(19) United States
(12) Patent Application Publication
(10) Pub. No.: US 2010/0214482 A1
(43) Pub. Date: Aug. 26, 2010

(54) SYSTEM AND METHOD FOR BROADCAST TOWER LOCATION IN A DEVICE HAVING A TELEVISION SIGNAL RECEIVER

(75) Inventor: Byung C. Kang, Downey, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 12/392,914

(22) Filed: Feb. 25, 2009

(51) Int. Cl. H04N 5/445; H04N 5/50

(52) U.S. Cl. 348/563; 348/731; 348/E05.099; 348/E05.097

(57) ABSTRACT

A system and method for locating broadcast towers in an electronic device including a television signal receiver are provided. The system allows a user to have an easy access to information on local television transmission towers while assisting the adjustment of an antenna. One embodiment of the system includes a database; a data communications network; an antenna; and an electronic device having access to the database over the network. The device includes a tuner configured to receive a television transmission signal; a display unit; and a processor configured to provide the display unit with information on local television transmission towers based at least partly on data received over the network. The information further includes the signal strength levels of channels provided by the television transmission towers. The processor is further configured to determine the signal strength level of the channel from the quality of the reception of the television transmission signal.

### BACKGROUND OF THE INVENTION

1. Field of the Invention

The present invention relates to a television, and particularly to a system for improving the reception of broadcast signals for a television.

2. Description of the Related Technology

Televisions typically receive broadcast television signals, including video and audio components, from external sources. Such television signals may be broadcast over the air from television transmission towers. In some countries, for example, the United States, television signals are also transmitted to televisions, using, for example, a cable network or satellite transmission.

Referring to FIG. 1, television transmission towers may be spread apart from one another with respect to a television. For example, a television 100 may receive broadcast signals from television transmission towers T1-T5 that are positioned in different directions with respect to the television 100. Television transmission towers that can provide signals to televisions within a geographical area can be referred to as local television transmission towers in the context of this document.

Televisions are typically equipped with an indoor antenna and/or outdoor antenna to receive television signals broadcast over the air from local television transmission towers. In many instances, the position and orientation of the antenna of a television may significantly affect the quality of video and audio reproduced by the television. In certain instances, an ill-positioned antenna may not receive signals from certain television transmission towers which would otherwise be receivable.

The locations of local television transmission towers within a certain geographical area, if known, can help position and orient television antennas so as to enhance the reception of broadcast signals. In addition, if distances between the television and the local television transmission towers are known, the television user may determine how far the antenna needs to support. If the user can have information on the distribution of the towers, he or she can select between a uni-directional antenna and a multi-directional antenna.

Television transmission tower location information is available online in some countries. However, many television users do not utilize such information either because they are not aware of the availability of such information or because they do not know how to find and/or use it. Thus, there is a need for a system that improves access to such information while effectively assisting utilization of such information for improving reception of broadcast signals.

### SUMMARY OF CERTAIN INVENTIVE ASPECTS

One inventive aspect is an electronic device which includes: a tuner configured to receive a television transmission signal including a video component; a display unit configured to display the video component, the display unit including a screen; a network transceiver configured to connect to a data communications network; and a processor configured to provide the display unit with information on one or more television transmission towers based at least partly on data received over the network. The information further includes the signal strength level of a channel provided by one of the television transmission towers, and the processor is further configured to determine the signal strength level of the channel from the quality of the reception of the television transmission signal.

Another inventive aspect is a system for providing information on television transmission towers. The system includes a server that includes a database including information on television transmission towers. The server is in data communication with an electronic device over a data communications network. The electronic device is configured to receive a television transmission signal including a video component via an antenna. The electronic device includes: a tuner configured to receive the television transmission signal via the antenna; a display unit configured to display the video component, the display unit including a screen; and a processor configured to provide the display unit with information on one or more television transmission towers based at least partly on data received over the network from the database. The information further includes the signal strength level of a channel provided by one of the television transmission towers, and the processor is further configured to determine the signal strength level of the channel from the quality of the reception of the television transmission signal.

Yet another inventive aspect is a method of providing information on television transmission towers. The method includes: accessing, by an electronic device including television functionality, a database including information on television transmission towers to obtain data on local television transmission towers in a geographical region; and receiving, by the electronic device, a television transmission signal including a video component through an antenna from one of the local television transmission towers. The method also includes determining, by the electronic device, the signal strength level of a channel provided by the one of the local television transmission towers, based at least partly on the quality of the reception of the television transmission signal; and displaying, by the electronic device, information on the local television transmission towers based at least partly on the data, wherein the information further comprises the signal strength level of the channel.

### BRIEF DESCRIPTION OF THE DRAWINGS

FIG. 1 is a diagram illustrating a television and local television transmission towers.

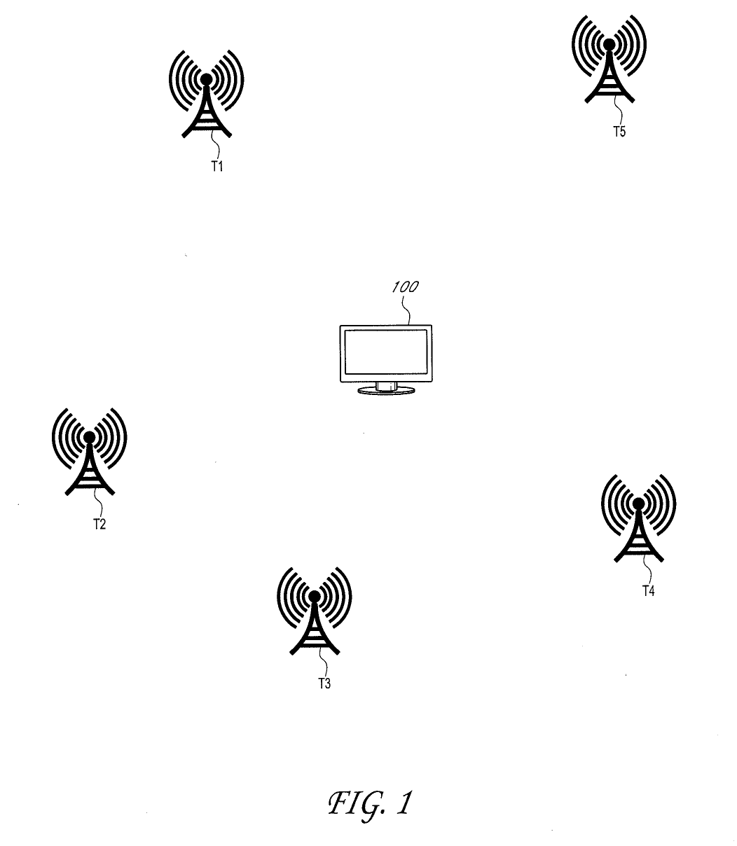

FIG. 2A is a diagram illustrating a television with an outdoor antenna according to one embodiment.

FIG. 2B is a diagram illustrating a television with an indoor antenna according to another embodiment.

FIG. 3 is a block diagram illustrating a system for locating local television transmission towers according to one embodiment.

FIG. 4 is a flowchart illustrating a method of providing information on local television transmission towers according to one embodiment.

FIG. 5 is a television screen for inputting the address of the location of a television for providing information on local television transmission towers according to one embodiment.

FIG. 6 is a television screen showing local television transmission towers for providing information on local television transmission towers according to one embodiment.

FIG. 7 is a television screen showing detailed information on a local television transmission tower according to one embodiment.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements.

### Television System for Locating Local Transmission Towers

In one embodiment, a system provides a television with information on television transmission towers. The system may include a database including information on television transmission towers; a data communications network; an antenna; and a television in communication with the database over the network. The television may include a tuner configured to receive a television transmission signal including a video component through the antenna; and a display unit configured to display the video component. The television may further include a processor configured to provide the display unit with information on one or more television transmission towers based at least partly on data received over the network. The information may further include the signal strength level of a channel provided by one of the television transmission towers. The processor may be further configured to determine the signal strength level of the channel from the quality of the reception of the television transmission signal.

In the context of this document, the term “television” refers to a device including a television signal receiver or television tuner, not limited to a conventional television set. Thus, the term “television” may refer to any electronic device that has television signal reception capability. Examples of such electronic devices include, but are not limited to, general purpose computers with a television signal receiver, car audio/video systems, portable devices (e.g., PDAs and cellular phones), home appliances (e.g., refrigerators, microwaves, washers, dryers, and dish washers), electronic billboards, vending machines, wrist watches, clocks, and global positioning system (GPS) devices or navigation devices having a television functionality.

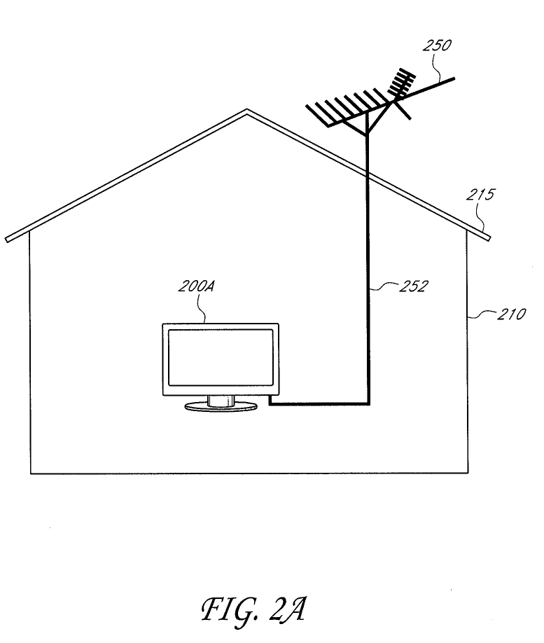

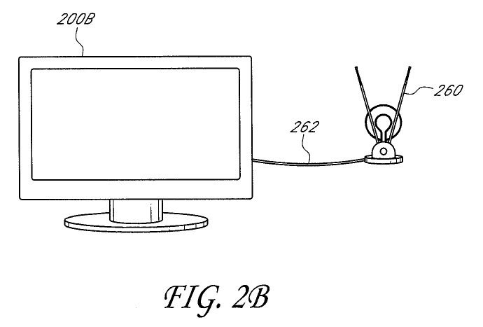

Referring to FIG. 2A, a television having an outdoor antenna according to one embodiment will be described below. The illustrated television 200A is located inside a building 210. The building 210 includes a roof 215 and an outdoor antenna 250 positioned on the roof 215.

The television 200A may be of any suitable type, including, but not limited to, a cathode ray tube (CRT) television, a liquid crystal display (LCD) television, a plasma television, Digital Light Processing™ (DLP) television, and an organic light emitting diode (OLED) television. The television 200A may have one or more of analog television signal reception capability and digital television signal reception capability.

The outdoor antenna 250 is electrically connected to the television 200A by a cable or wire 252. In other embodiments, the antenna 250 may be wirelessly connected to the television 200A. The outdoor antenna 250 may be uni-directional, multi-directional, or omni-directional. The outdoor antenna 250 can be of any suitable type, including, but not limited to, VHF antennas, UHF antennas, and VHF/UHF combo antennas. Examples of outdoor antennas include, but are not limited to, dipole antennas, stacked dipole antennas, reflector antennas, log-periodic dipole arrays (LPDA), and Yagi antennas.

Referring to FIG. 2B, a television having an indoor antenna according to another embodiment will be described below. The illustrated television 200B is located inside a building (not shown). In other embodiments, the television 200B may be placed outdoor. The details of the television 200B can be as described above with respect to the television 200A of FIG. 2A.

The indoor antenna 260 is electrically connected to the television 200B by a cable or wire 262. The indoor antenna 260 may be uni-directional, multi-directional, or omni-directional. The indoor antenna 260 can be of any suitable type. Examples of indoor antennas include, but are not limited to, VHF antennas, UHF antennas, and VHF/UHF combo antennas.

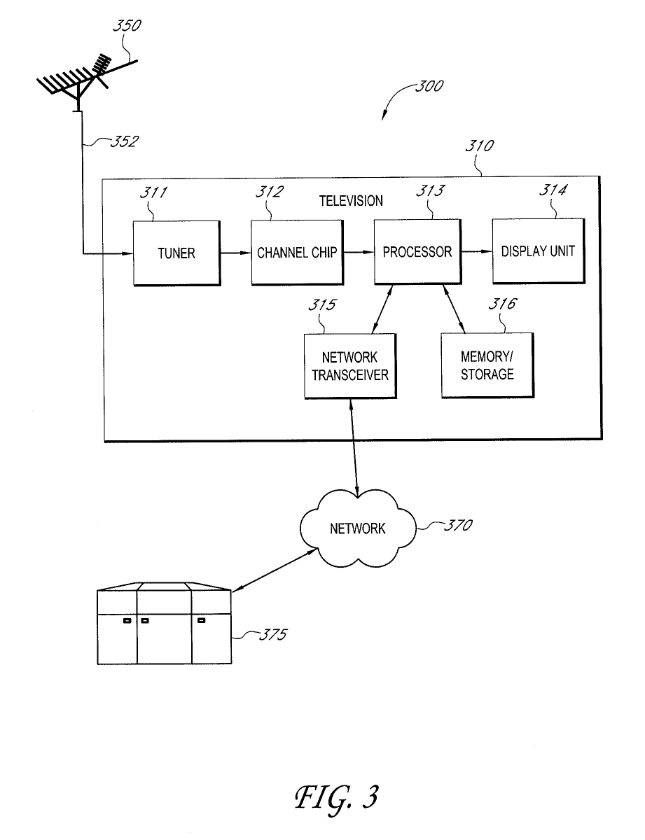

Referring to FIG. 3, one embodiment of a television system for providing information on local television transmission towers will be described below. The illustrated television system 300 includes a television 310, an antenna 350, a cable 352, a data communications network 370, and a server 375. Although not shown, the television 310 can also include an audio unit that includes one or more speakers. A skilled technologist will appreciate that the television 300 may include any other components for the operation of the television 310.

The illustrated television 310 is a digital television. In other embodiments, the television may be an analog television. The television 310 may include a tuner 311, a channel chip 312, a processor 313, a display unit 314, a network transceiver 315, and a memory or storage 316. The tuner 311 receives an RF signal from the antenna 350 via the cable 352, and provides an intermediate signal to the channel chip 312. The channel chip 312 provides a signal-to-noise ratio to the processor 313. The processor 313 is in communication with the network transceiver 315 and the memory 316. The processor 313 is also configured to provide video and audio signals to the display unit 314 and the audio unit.

The tuner 311 serves to convert a radio frequency (RF) television transmission signal to an intermediate frequency (IF) signal. The RF television transmission signal can include audio and video components, which may be further processed for use by the audio unit and display unit 314, respectively. Different types of tuners may be used for different television standards, such as PAL, NTSC, ATSC, SECAM, DVB-C, DVB-T, T-DMB, and open cable. In the illustrated embodiment, the tuner 311 may select only one frequency or channel at a time. In other embodiments, the tuner 311 may include multiple sub-tuners and select multiple frequencies or channels simultaneously, using the sub-tuners.

The channel chip 312 serves to receive and demodulate the IF signal. In the illustrated embodiment where the television 310 is a digital television, the channel chip 312 may be a vestigial sideband (VSB) demodulator for an ATSC signal or a quadrature amplitude modulation (QAM) demodulator for a QAM-modulated cable signal. The channel chip 312 may be also configured to calculate a signal-to-noise ratio from the demodulated signal. In another embodiment where the television 310 is an analog television, the channel chip 312 may be an analog demodulator.

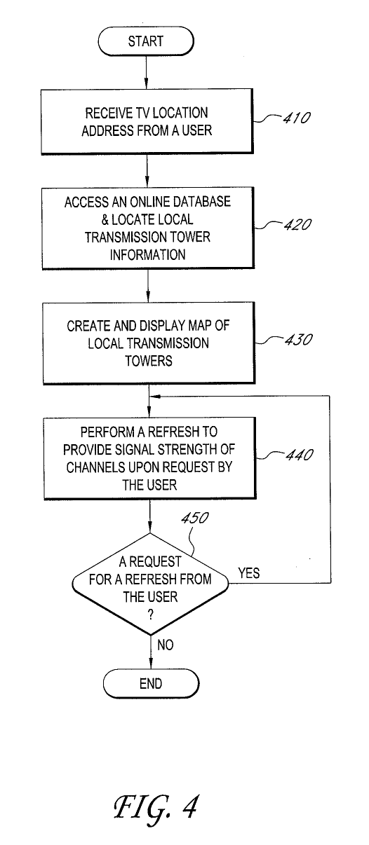

The processor 313 may be a microprocessor of any suitable type for controlling the operation of the television 310. In other embodiments, a processor that can be used as a central processing unit (CPU) of a general purpose computer may be used as the processor 313. The processor 313 serves to perform a method which will be described below in connection with FIG. 4. The processor 313 is also configured to provide the signal-to-noise ratio to the display unit 314, and display the ratio on the screen of the display unit 314, either by numeric value or by box graph.

The display unit 314 serves to reproduce the video component of a broadcast television signal. The display unit 314 may include a display screen and components configured to display video on the screen. The configuration of the display unit 314 can vary widely, depending on the type of the display unit. Example types of the display unit 314 include, but are not limited to, CRT, LCD, plasma display panel, DLP, and OLED.

The network transceiver 315 serves to interface the television 310 with the network 370. The configuration of the network transceiver 315 can vary widely, depending on the type of the network 370. In an embodiment where the network is the Internet, the network transceiver 315 may include an Ethernet modem that can provide communication interface with the Internet.

The memory 316 serves to store electronic data. Examples of memories include, but are not limited to, a hard disk, a flash memory, a RAM, a ROM, or a suitable combination of the foregoing.

The illustrated antenna 350 is electrically connected to the television 310 via the cable 352. The antenna 350 may be connected to the tuner 311 of the television 310. The illustrated antenna 350 is an outdoor antenna, as described above in connection with FIG. 2A. In other embodiments, the antenna 350 may be an indoor antenna, as described above in connection with FIG. 2B. The details of the antenna 350 can be as described above with respect to FIG. 2A or 2B.

The data communications network 370 may be the Internet. In other embodiments, any suitable type of network, e.g., a public switched telephone network (PSTN), a local area network (LAN), a wide area network (WAN), a cable television network, or a satellite television network, can be used as the network 370. The network 370 may be provided using a wired connection or a wireless connection. A skilled technologist will appreciate that any suitable network can be adapted for the network 370.

The server 375 serves to store information on television transmission towers in the entire world, one or more geographical regions (for example, North America, South America, Europe, East Asia, Southeast Asia, South Asia, Middle East, Central Africa, or Oceania), one or more countries, or one or more areas in a country (for example, the state of California in the United States). In one embodiment, the server 375 may include a television transmission tower database of the Federal Communications Commission (FCC) of the United States.

The server 375 may be also configured to provide the information to the television 310 upon a request from a television. When the server 375 receives a request from a television (for example, the television 310) the server 375 generates information on television transmission towels in a local area where the television 310 is located, and sends the information to the television over the network 370.

### Method of Providing Information on Local Television Transmission Towers

Referring to FIGS. 3 and 4-7, the operation of the system 300 of FIG. 3 according to one embodiment will be described below. Referring to FIG. 4, the television 310 receives the address of the location of the television 310 from a user at block 410.

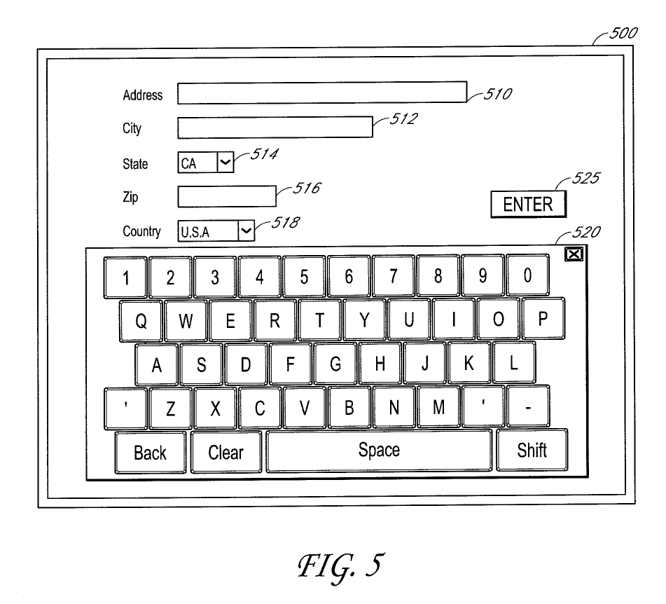

The television 310 provides an option of providing information on local television transmission towers on the menu on the screen of the television 310. If the user selects the option, the television 310 may provide an address input screen 500 for receiving address information from the user, as shown in FIG. 5. The illustrated address input screen 500 includes an address blank 510, a city blank 512, a state selection box 514, a zip code blank 516, a country selection box 518, a keyboard array 520, and an enter button 525. In certain embodiments, the address input screen 500 may be implemented in a touch screen display. The user may input the address where the television is located by filling the address blank 510, the city blank 512, the zip code blank 516 and selecting a state in the state selection box 514 and a country in the country selection box 518, using the keyboard array 520. The formats of the address blank 510, the city blank 512, the state selection box 514, the zip code blank 516, and the keyboard array 520 may be changed by selecting a different country in the country selection box 518. In some embodiments, a default format can be set up during manufacturing of the television 310. The user may complete inputting the address information by clicking the enter button 525.

In certain embodiments, the television 310 may include a global positioning system (GPS). In such embodiments, the television 310 can automatically locate its position without receiving address information from the user.

Referring back to FIG. 4, at block 420, the television 310 accesses the database of the server 375 over the network 370 (FIG. 3). The television 310 provides the address information to the server 375. The server 375 generates information on local television transmission towers in a geographical area, based on the address information. The local television transmission tower information may include locations of television transmission towels within a radius from the location of the television. The radius may be selected based on the effective transmission distance of an RF signal provided by such a local television transmission tower. The radius may be about 10, 20, 30, 40, 50, 60, 70, 80, 90, 100, 110, 120, 130, 140, 150, 160, 170, 180, 190, 200, 300, 400, or 500 miles. A user may also select one of the radii as a default radius.

The local television transmission tower information may include a physical channel number and frequency provided by the towers. The information may also include one or more virtual channel numbers found in each of the physical channels. The term “virtual channel” refers to a channel designation which differs from the physical channel or frequency provided by a television transmission tower. In some instances, a physical channel may include multiple virtual channels. A “virtual channel” may also be referred to as a “logical channel number.” The information may further include a distance between the location of the television 310 and one or more of the local television transmission towers. The information may also include the directions of the towers relative to the position of the television 310 and a signal-to-noise ratio of a physical or virtual channel.

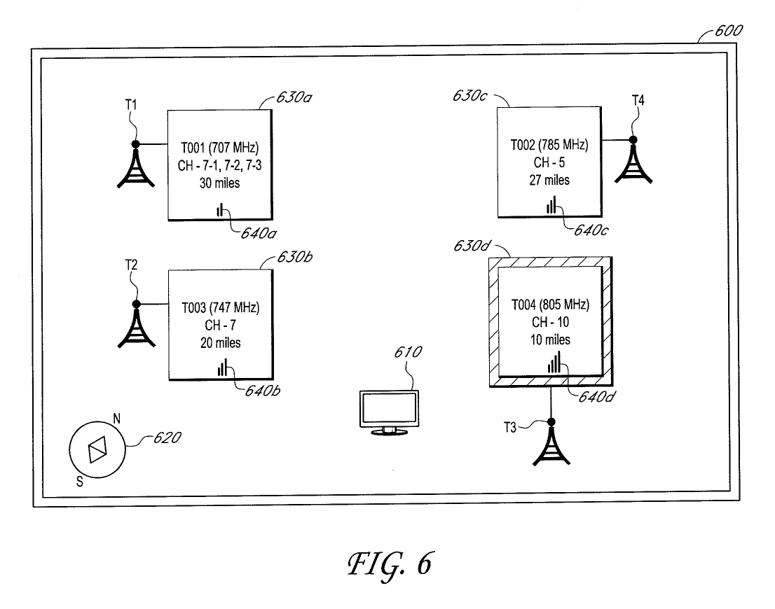

The server 375 may provide the local television transmission tower information to the television 310 over the network 370. At block 430, upon receiving the information, the television 310 may create and display a map showing the local transmission towers and the local transmission tower information, based at least partly on the information provided by the server 375. One example of the map is shown in FIG. 6.

The illustrated map 600 shows a television icon 610, local television transmission tower icons T1-T4, and a compass icon 620. The television icon 610 represents the location of the television 310, based on the address information input by the user, as shown in FIG. 5. The local television transmission tower icons T1-T4 represent locations of the local television transmission towers relative to the location of the television 310. Detailed information 630a-630d on each of the television transmission towers T1-T4 is displayed next to the tower T1-T4. The detailed information includes a physical channel number and frequency provided by the tower, one or more virtual channel numbers found in the physical channel, a signal-to-noise ratio of the physical or virtual channel, and a distance between the television 310 and the local television transmission tower T1-T4.

The map 600 may be oriented in the direction in which the user watches the television screen. For example, in FIG. 6, the backside of the television screen showing the map 600 faces northwest and the television screen faces southeast. The locations of television transmission towers T1-T4 on the map 600 represent actual directions relative to the television screen such that the user can simply regard the towers T1-T4 as being located in those directions.

The actual north and south directions are shown by the compass icon 620. This function may be provided by an electronic compass inside the television 310. The electronic compass may generate a signal indicative of the direction in which the device is oriented. The processor 313 may be configured to orient the map based at least partly on the signal.

The map 600 may also provide signal strength information on at least one of the television transmission towers T1-T4 on the map 600. In the illustrated embodiment, the signal strength levels of the physical channels are provided in a form of signal strength bars 640a-640d. In other embodiments, the signal strength levels may be provided in number or percentage.

In one embodiment where the television 310 includes a single tuner, the map 600 shows the signal strength bars of a channel to which the tuner is currently tuned (for example, 640d in FIG. 6). The map 600 may show the signal strength levels of the other channels from the last time the channels were selected. In other embodiments where the television 310 includes multiple tuners, the map 600 may show signal strength levels of channels to which the tuners are currently tuned, and optionally the signal strength levels of other channels from previous tuning to the other channels if there is a greater number of available channels than the number of tuners in the television 310. In certain embodiments, if the user selects one of the towers shown on the map, the tuner of the television is tuned to the channel of the selected tower, and the signal strength level of the tower may be updated.

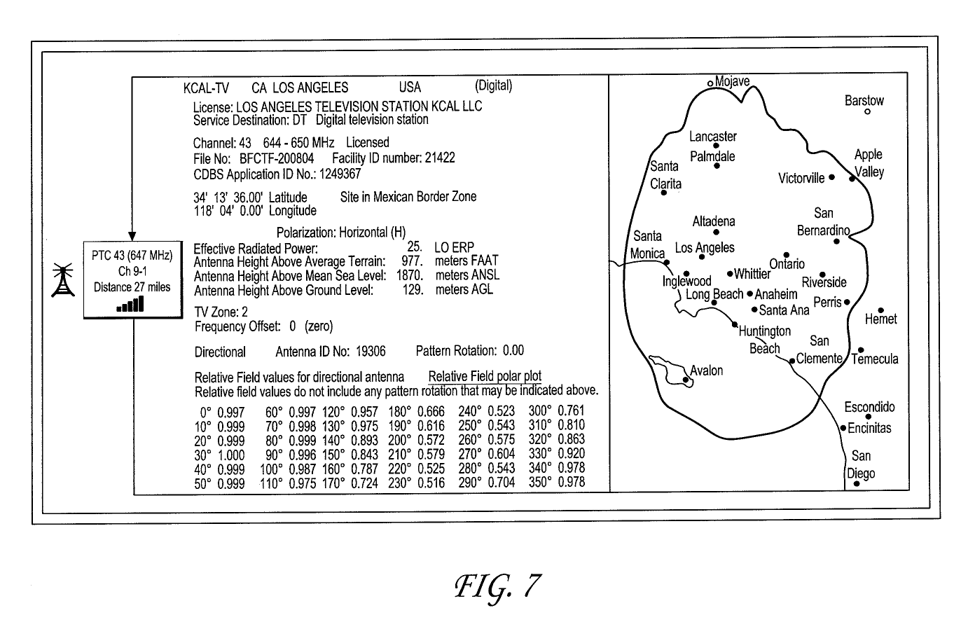

If the user wishes more detailed information on a specific local television transmission tower, it can select the tower by clicking the icon of it on the map 600. Then, the television 310 provides detailed information, for example, call signs, tower elevation data, service contour map, as shown in FIG. 7. The term “call sign” refers to a unique designation for a transmitting station.

Referring back to FIG. 4, the television may perform a refresh step at block 440. During the refresh step, the tuner(s) of the television tunes to each of the physical channels one by one, and updates the signal strength levels of the towers T1-T4. Then, the television 310 updates the map 600 with the current signal strength levels of the towers T1-T4.

The user may adjust the position and orientation of the antenna 350, based at least partly on the information shown in the map. After adjusting the antenna 350, the user may request another refresh step to update the signal strength levels of the towers T1-T4. At block 450, if there is a request for a refresh from the user, the process goes back to the block 440. If no, the process is completed, and the television may return to its normal operation mode.

In other embodiments, the antenna 350 may be automatically adjustable, using an electronic or mechanical system. In such embodiments, the adjustment of the antenna 350 can be automatically performed by repeating the steps 430 to 450 without manual adjustment by the user. A skilled technologist will appreciate that any suitable electronic and/or mechanical system may be adapted for such automatic antenna adjustment.

The system of the embodiments described above provide a television with access to information on local television transmission towers without using a general purpose computer. In addition, the detailed map showing towers' locations and actual directions relative to the television can assist a user to efficiently adjust the orientation and direction of the antenna. Furthermore, signal strength levels provided by the television can further assist the adjustment of the antenna.

The foregoing description is that of embodiments of the invention and various changes, modifications, combinations and sub-combinations may be made without departing from the spirit and scope of the invention, as defined by the appended claims.

What is claimed is:

1. An electronic device comprising:
a tuner configured to receive a television transmission signal including a video component;
a display unit configured to display the video component, the display unit including a screen;
a network transceiver configured to connect to a data communications network; and
a processor configured to provide the display unit with information on one or more television transmission towers based at least partly on data received over the network, wherein the information further comprises the signal strength level of a channel provided by one of the television transmission towers, and wherein the processor is further configured to determine the signal strength level of the channel from the quality of the reception of the television transmission signal.

2. The device of claim 1, wherein the device comprises a television.

3. The device of claim 1, wherein the processor is configured to generate a map to be displayed on the screen, and wherein the map includes the information.

4. The device of claim 3, wherein the map provides the locations of the one or more television transmission towers relative to the location of the device.

5. The device of claim 4, wherein the map is oriented to indicate the actual directions of the one or more television transmission towers when a user watches the screen.

6. The device of claim 5, further comprising an electronic compass generating a signal indicative of the direction in which the device is oriented, wherein the processor is configured to orient the map based at least partly on the signal.

7. The device of claim 1, wherein the information comprises one or more of a physical channel number, a frequency, and a virtual channel number of the one or more television transmission towers.

8. The device of claim 1, wherein the information comprises a distance between the device and one of the television transmission towers.

9. The device of claim 1, wherein the processor is further configured to provide the display unit with one or more of call signs, tower elevation data, and a service contour map, based at least partly on the data.

10. The device of claim 1, wherein the processor is further configured to update the signal strength level of the channel.

11. The device of claim 10, wherein the processor is configured to refresh the signal strength levels of channels provided by the one or more television transmission towers.

12. The device of claim 1, wherein the tuner is configured to receive the television transmission signal via an antenna.

13. The device of claim 1, wherein the processor is configured to receive address information indicative of the location of the device from a user, and to send the address information over the network.

14. The device of claim 1, wherein the display unit comprises a touch screen.

15. A system for providing information on television transmission towers, the system comprising:
a server comprising a database including information on television transmission towers,
wherein the server is in data communication with an electronic device over a data communications network;
wherein the electronic device is configured to receive a television transmission signal including a video component via an antenna; and
wherein the electronic device comprises:
a tuner configured to receive the television transmission signal via the antenna;
a display unit configured to display the video component, the display unit including a screen; and
a processor configured to provide the display unit with information on one or more television transmission towers based at least partly on data received over the network from the database, wherein the information further comprises the signal strength level of a channel provided by one of the television transmission towers, and wherein the processor is further configured to determine the signal strength level of the channel from the quality of the reception of the television transmission signal.

16. The system of claim 15, wherein the processor is configured to generate a map to be displayed on the screen, and wherein the map includes the information.

17. The system of claim 16, wherein the map provides the locations of the one or more television transmission towers relative to the location of the device.

18. The system of claim 17, wherein the map is oriented to indicate the actual directions of the one or more television transmission towers when a user watches the screen.

19. The system of claim 18, wherein the electronic device further comprises an electronic compass generating a signal indicative of the direction in which the device is oriented, and wherein the processor is configured to orient the map based at least partly on the signal.

20. The system of claim 15, wherein the processor is configured to update the signal strength level of the channel or the signal strength levels of channels provided by the one or more television transmission towers.

21. The system of claim 15, wherein the data communications network comprises the Internet.

22. A method of providing information on television transmission towers, the method comprising:
accessing, by an electronic device including television functionality, a database including information on television transmission towers to obtain data on local television transmission towers in a geographical region;
receiving, by the electronic device, a television transmission signal including a video component through an antenna from one of the local television transmission towers;
determining, by the electronic device, the signal strength level of a channel provided by the one of the local television transmission towers, based at least partly on the quality of the reception of the television transmission signal; and
displaying, by the electronic device, information on the local television transmission towers based at least partly on the data, wherein the information further comprises the signal strength level of the channel.

23. The method of claim 22, further comprising receiving an input indicative of the location of the electronic device from a user, wherein the geographical region is selected based at least partly on the received input.

24. The method of claim 23, wherein displaying the information comprises displaying a map which includes the information.

25. The method of claim 24, wherein the map provides the locations of the local television transmission towers relative to the location of the electronic device.

26. The method of claim 25, wherein displaying the map comprises orienting the map to indicate the actual directions of the local television transmission towers when viewed by a user.

27. The method of claim 22, further comprising updating the signal strength level of the channel.

28. The method of claim 22, further comprising refreshing the signal strength levels of channels of the local television transmission towers.

29. The method of claim 22, wherein the information comprises one or more of a physical channel number, a frequency, a virtual channel number, a call sign, tower elevation data, a service contour map, and a distance between the electronic device and one of the local television transmission towers.
